(19) United States
(12) Patent Application Publication
(10) Pub. No.: US 2010/0262992 A1
(43) Pub. Date: Oct. 14, 2010

(54) METHODS AND APPARATUS FOR OVERLAYING CONTENT ONTO A COMMON VIDEO STREAM

(75) Inventor: Steven M. Casagrande, Castle Rock, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies L.L.C., Englewood, CO (US)

(21) Appl. No.: 12/422,398

(22) Filed: Apr. 13, 2009

(51) Int. Cl. H04N 5/445; H04N 9/67; H04N 7/025

(52) U.S. Cl. 725/34; 348/660; 348/563; 348/E09.047; 348/E05.099

(57) ABSTRACT

Described herein are techniques for presenting non-common content in association with common content to end users. A television receiver receives common content as well as one or more portions of non-common content. The television receiver determines whether to present the non-common content based on criteria associated with the non-common content and parameters associated with the television receiver. As appropriate, the non-common content may be overlaid onto the common content, presenting the user with content that may be localized or otherwise personalized for the user.

### BACKGROUND

In television broadcasting, content is often transmitted across state, regional or country borders into multiple jurisdictions. For example, in satellite television broadcasting, different jurisdictions may have access to the same content feed. Because each jurisdiction receives the same content feed, the content is not localized for particular areas. While it is appropriate for each jurisdiction to receive the same content, there are often portions of the content which should be different for each jurisdiction. For example, an automobile advertisement may be substantially the same across multiple regions, but the pricing or contact information associated with the advertisement may be different for each region. For example, the price may be presented as Euros in Germany and Francs in Switzerland. Further, news and emergency alerts for one jurisdiction may be inapplicable for another jurisdiction. For example, an emergency alert stating that a typhoon is approaching may be important for Hong Kong viewers but the same alert should not be presented to viewers in Taiwan. The amount of time that localized content should be presented is often minimal, and thus, it would not be desirable to transmit the same programming as multiple video streams into each region in order to give flexibility for presentation of the short duration of the localized content.

### BRIEF DESCRIPTION OF THE DRAWINGS

The same number represents the same clement or same type of element in all drawings.

FIG. 1 illustrates an embodiment of a satellite television communication system.

FIG. 2 illustrates an embodiment of a television receiver of FIG. 1.

FIG. 3 illustrates an embodiment of a compound stream received by the television receiver of FIG. 1.

FIG. 4 illustrates an embodiment of a screenshot of a video stream of FIG. 3.

FIG. 5 illustrates another embodiment of a screenshot of the video stream of FIG. 3.

FIG. 6 illustrates a process for presentation of a video stream.

FIG. 7 illustrates another embodiment of a process for presenting a video stream.

### DETAILED DESCRIPTION

The various embodiments described herein generally provide apparatus, systems and methods which facilitate the reception, processing, and outputting of content from one or more sources for presentation to end-users. More particularly, the various embodiments described herein provide techniques for presenting non-common content in association with common content to end users. As appropriate, the non-common content may be overlaid onto the common content, presenting the user with content that may be localized or otherwise personalized based on various criteria. In short, the various embodiments described herein provide overlaying non-common content onto common content of a video stream.

In at least one embodiment, the content to be received, processed, outputted and/or communicated may come in any of various forms including, but not limited to, audio, video, data, information, or otherwise. As used herein, “content” refers to information communicated via a media (e.g., on a television screen or otherwise) without concern as to the design, placement or layout of the information on the media. It is to be appreciated, however, that “content” includes videos, video clips, photographs, sound recordings, text Files, graphical images and the like.

In at least one embodiment, a receiving device, such as a television receiver, receives a compound stream that includes common video content and one or more portions of non-common content. In at least one embodiment, the compound stream may additionally include criteria specifying when to display the non-common content. In some embodiments, a decision regarding whether to display the non-common content may depend on an identifier associated with the non-common content. Thus, the identifier may act as criteria for determining whether to display the non-common content. The television receiver processes the criteria and one or more parameters associated with the television receiver to determine whether to output the non-common content. The television receiver outputs the common content, and if appropriate, overlays the non-common content onto a portion of the common video content. In at least one embodiment, if the television receiver determines that the non-common content should not be displayed, then the television receiver outputs the common content without an overlay.

In at least one embodiment, the compound stream includes multiple portions of non-common content. For example, the compound stream may include an advertisement in the common video content and each portion of non-common content may be associated with information for a particular region. The television receiver may then process criteria associated with the television receiver, such as a geographic identifier, to determine which of the portions of non-common content, if any, to overlay onto the advertisement.

In at least one embodiment, the compound stream comprises a digital video broadcasting (DVB) video stream. The common video stream may be associated with a first packet identifier (PID) and the portion of non-common content may be associated with a second PID. If there are multiple portions of non-common content, then each portion may be associated with a unique PID. In at least one embodiment, each portion of non-common content is a DVB subtitling image. The television receiver receives each of the PIDs associated with the DVB compound stream and determines whether to present any of the non-common content. Responsive to determining that the non-common content should be presented, the television receiver overlays the non-common content onto the common video content at the appropriate temporal location within the compound stream.

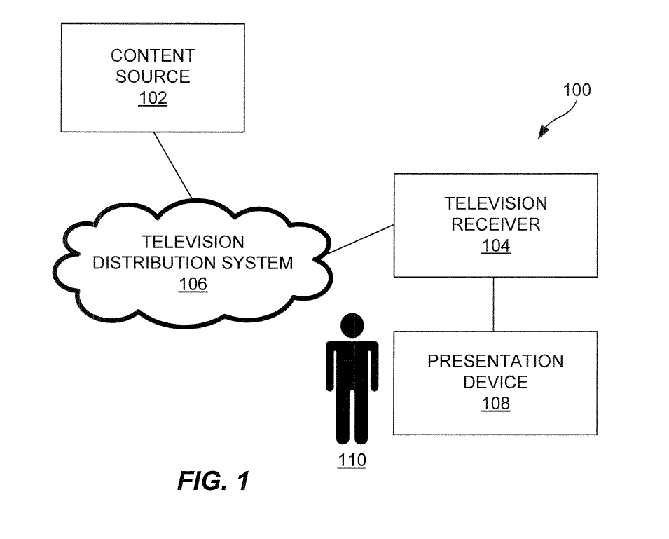

FIG. 1 illustrates an embodiment of a satellite television communication system 100. The communication system 100 includes a content source 102, a television receiver 104, a television distribution system 106 and a presentation device 108. Each of these components will be discussed in greater detail below. The communication system 100 may include other components, elements or devices not illustrated for the sake of brevity of discussion.

The content source 102 is operable for receiving, generating and communicating content to one or more television receivers 104. The content to be received, processed, outputted and/or communicated may come in any of various forms including, but not limited to, audio, video, data, information, or otherwise. In at least one embodiment, the content source 102 is operable for receiving various forms and types of content from other sources, aggregating the content and transmitting the content to the television receivers 104 through the television distribution system 106. It is to be appreciated that the content source 102 may receive practically any form and/or type of information from one or more sources including streaming television programming, recorded audio or video, electronic programming guide data and the like. In at least one embodiment, the content source 102 may be embodied as a transmission facility of the television distribution system 106. Exemplary content sources 102 include over-the-air transmission facilities, cable television distribution head-ends, satellite television uplink centers, broadband or internet servers and the like.

The television distribution system 106 is operable to transmit content from the content source 102 to the television receiver 104. The television distribution system 106 may comprise any type of wired (e.g., cable and fiber) and/or wireless (e.g., cellular, satellite, microwave, and other types of radio frequency) communication mediums and any desired network topology (or topologies when multiple mediums are utilized). Exemplary television distribution systems 106 include terrestrial, cable, satellite and internet protocol television (IPTV) distribution systems. In at least one embodiment, the television distribution system 106 broadcasts or multicasts content to a plurality of television receivers 104. The television distribution system 106 may also distribute content to a specific addressable television receiver 104 (e.g., video-on-demand and the like). In at least one embodiment, the television receiver 106 may be alternatively implemented as a playback device that accesses content from storage mediums, such as a digital video disk (DVDs) or other type of optical disks.

The television receiver 104 is operable to receive content from the television distribution system 106, and to output the received content for presentation by the presentation device 108. In at least one embodiment, the presentation device 108 is a display device (e.g., a television) configured to display content to a user 110. The television receiver 104 may receive an audio/video stream in any format (e.g., analog or digital format), and output the audio/video stream for presentation by the presentation device 108. For example, the television receiver 104 may be a satellite, cable, over-the-air, broadband or other type of television receiver that receives and demodulates television signals that are outputted for display on a display device (e.g., a television). As used herein, a television receiver 104 may also be referred to as a set-top box, which is a television receiver that is located externally with respect to a display device. The television receiver 104 may be further configured to output menus and other information that allow a user to control the output of audio/video content by the television receiver 104. In some embodiments, the television receiver 104 and the presentation device 108 may be integrated as a device combining the functionality of a display device and a set-top box, digital video recorder (DVR) or the like.

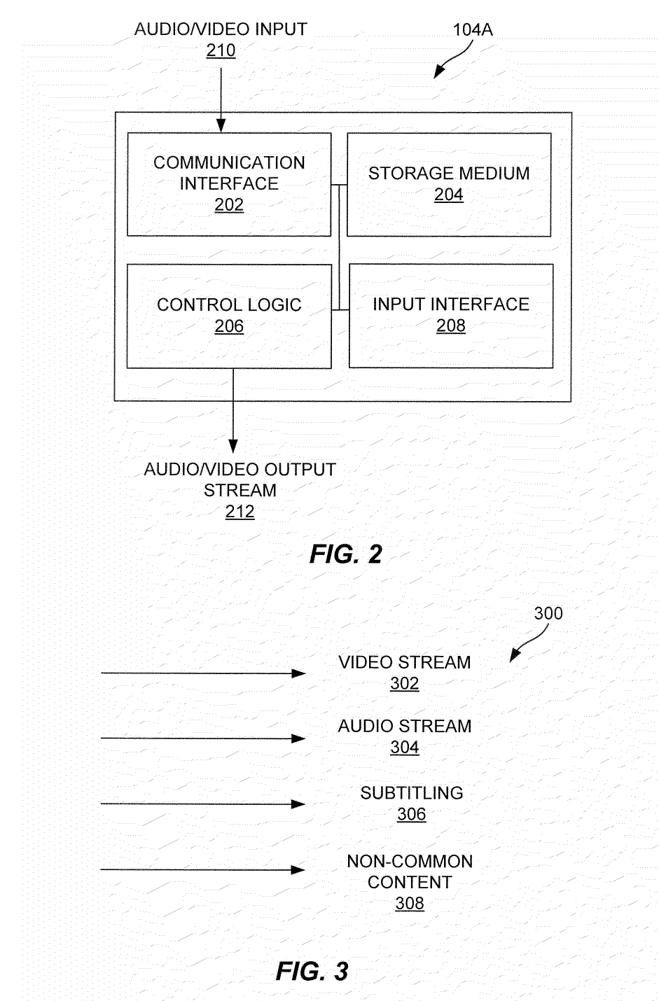

FIG. 2 illustrates an embodiment of a television receiver of FIG. 1. FIG. 2 will be discussed in reference to the communication system 100 illustrated in FIG. 1. The television receiver 104A includes a communication interface 202, a storage medium 204, control logic 206 and an input interface 208. Each of these components will be discussed in greater detail below. The television receiver 104A may include other elements, components or devices which are not illustrated for the sake of brevity.

The communication interface 202 is operable to receive an audio/video input 210 from the content source 102. More particularly, in at least one embodiment, the communication interface 202 receives and tunes a television signal including television programming. The communication interface 202 may receive an over-the-air broadcast, a direct broadcast satellite signal, a cable television signal or an internet protocol television (IPTV) signal and tune the audio/video input 210 to extract the selected television programming. In at least one embodiment, the communication interface 202 may comprise multiple tuners, utilized by the television receiver 104A to present and/or record multiple television programs simultaneously.

The storage medium 204 is operable to store electronic programming guide data and other system information utilized by the television receiver 104A. The storage medium 204 may comprise any type of non-volatile memory appropriate for storing data associated with the television receiver 104A. Exemplary storage mediums 204 include semi-conductor memory, disk drives (e.g., magnetic memory), optical disks (e.g., DVDs) and flash memory. In at least one embodiment, the storage medium 204 may be utilized to store parameters associated with the television receiver 104A. For example, the storage medium 204 may store a geographic identifier specifying the location of the television receiver 104A. In at least one embodiment, the geographic identifier is provided to the television receiver 104A in an entitlement management message (EMM) transmitted through the television distribution system 106. In other implementations, the parameter could be set at the time of manufacture of the television receiver 104A or set by the user 110.

In some embodiments, the television receiver 104A may optionally include DVR functionality to record and persistently store video signals received by the television receiver 104A. In some embodiments, a disk drive or other storage medium may be internally located within the television receiver 104A. In other embodiments, a disk drive or other storage medium may be located externally with respect to the television receiver 104A. The television receiver 104A may also utilize a combination of internal and external storage mediums 204 for storage of video signals and other data.

The control logic 206 is operable to control the operation of the television receiver 104A. The control logic 206 may be a single processing device or a plurality of processing devices that cooperatively operate to control the operation of the television receiver 104A. The control logic 206 may include various components or modules for processing and outputting audio/video content. Exemplary components or modules for processing audio/video content include a demodulator, a decoder, a decompressor, a conditional access module and a transcoder module.

The control logic 206 is operable to receive the audio/video input 210, received via the communication interface 202, and generate an audio/video output 212 based on the audio/video input 210 for display by an associated presentation device 108 (see FIG. 1). An audio/video output stream is outputted to the presentation device 108 for presentation to the user 110. The control logic 206 may incorporate circuitry to output the audio/video streams in any format recognizable by the presentation device 108, including composite video, component video, RF modulation, internet protocol (IP) streaming, SCART, Digital Visual Interface (DVI) and High-Definition Multimedia Interface (HDMI). The control logic 206 may also incorporate circuitry to support multiple types of these or other audio/video formats. In at least one embodiment, as described above, the television receiver 104A may be integrated with the presentation device 108 and the control logic 206 may be operable to control the presentation of the audio/video output stream.

The control logic 206 is operable for performing various video rendering operations on the audio/video input 210. For example, the control logic 206 may overlay various types of content onto a video stream, such as subtitling content or non-common content, as described below. In at least one embodiment, the content overlaid by the control logic 206 may be embodied as an image, such as a DVB subtitling image. The image includes a picture of printable characters and the control logic 206 overlays the image onto the video content when outputting the audio/video output 212. In another embodiment, the control logic 206 receives textual data and renders the textual data into an image that is overlaid onto video content during outputting of the audio/video output 212.

The input interface 208 is operable to receive data from a remote control. The data may be received from the remote control over a wired or wireless connection depending on desired design criteria. The input interface 208 may communicate with a remote control utilizing any type of IR or RF communication link. In at least one embodiment, the input interface 208 receives a key code from the remote control 106 and responsively provides the key code to the control logic 206. In some embodiments, the input interlace 208 may receive positional information from a scrolling device of the remote control 106, e.g., a touch pad, scroll wheel or the like. The data received from the remote control may be utilized by the control logic 206 to control the output of content by the control logic 206. For example, the user 110 may request to view subtitling data and the control logic 206 may output the audio/video output 212 including the subtitling data overlaid onto the video stream. Some of the data received by the input interface 208 may request to view electronic programming guide data, menus and the like.

In at least one embodiment, the audio/video input 210 is embodied as a compound stream with multiple components. Each component may be associated with a different PID that is tuned by the communication interface 212. When the user 110 selects a particular channel for viewing, the communication interface 202 identifies the PIDs associated with the channel and tunes the selected PIDs. The storage medium 204 may store a table identifying the particular PIDs associated with each channel that the communication interface 202 may receive. The table may be updated appropriately as the television provider updates the channel mapping information for the service.

FIG. 3 illustrates an embodiment of multiple streams of data received by the communication interface 202 of FIG. 1. The communication interface 202 receives a compound stream 300 including video content 302, audio content 304, subtitling content 306 and non-common content 308. The compound stream 300 may include other components, such as secondary audio content, electronic programming guide data, additional portions of non-common content and the like which are not illustrated for sake of brevity.

The communication interface 202 receives the compound stream 300 and the control logic 206 outputs the video content 302 and the audio content 304 in the audio/video output 212 for presentation by the presentation device 108. In at least one embodiment, the user 110 selects to view the subtitling content 306 by providing input to the television receiver 104A via an associated remote control. In at least one embodiment, the subtitling content 306 comprises a series of images which are overlaid by the control logic 206 onto the common video content 302 at appropriate temporal locations within the compound stream 300. For example, the audio content 304 may be in English and the subtitling content 306 may be the German equivalent of the English audio content 304. The control logic outputs the audio/video output 210, with the overlaid subtitling content 306, for presentation by the presentation device 108 (see FIG. 1). In at least one embodiment, there may be multiple instances of the subtitling 306, each covering a different language. For example, a particular program may have first subtitling information for Traditional Chinese, second subtitling information for Simplified Chinese and third subtitling information for English. Each instance of the subtitling 306 information may be carried as a separate PID.

The compound stream 300 may be associated with non-common content 308, which is presented to a subset of viewers depending on desired criteria. In at least one embodiment, the non-common content 308 may be transmitted a separate PID. In at least one embodiment, the non-common content 308 includes associated metadata specifying the criteria for presenting the non-common content 308. For example, the metadata may specify particular geographic regions where the non-common content 308 should be displayed. The control logic 206 processes the criteria specified by the metadata and the parameters associated with the television receiver 104 to determine whether to output the non-common content 308. For example, the storage medium 204 may store a geographic identifier specifying the geographic location of the television receiver 104A. If the geographic identifier corresponds with the criteria specifying whether to output the non-common content 308, then the control logic 206 overlays the non-common content 308 onto the video content 302 when outputting the audio/video output 212. Otherwise, the control logic 206 continues outputting the video content 302 without overlaying the non-common content 308 onto the video stream.

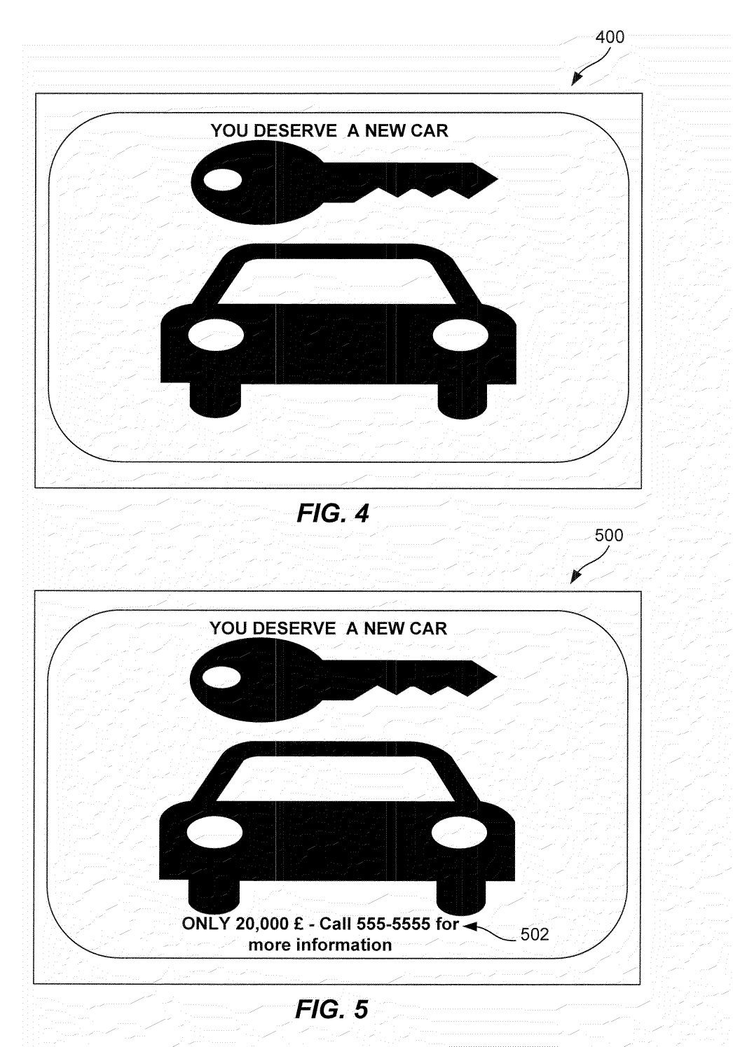

FIG. 4 illustrates an embodiment of a screenshot 400 of the audio/video output 212 of FIG. 2. The screenshot 400 of FIG. 4 illustrates the common video content 302 content transmitted across multiple regions. The common content in screenshot 400 illustrates an advertisement for an automobile that is presented in multiple regions. Absent from FIG. 4 is any localized information, such as pricing information or contact information for dealers. The user 110 would see to screenshot in FIG. 4 if the processing of the control logic 206 determines that the non-common content 308 should not be overlaid onto the video content 302.

FIG. 5 illustrates another embodiment of a screenshot 500 of the audio/video output 212 of FIG. 2. More particularly, the screenshot of FIG. 5 illustrates the video content 302 with the non-common content 308 overlaid thereupon. The user 110 is presented with the screenshot 500 when the control logic 206 determines that the display criteria associated with the non-common content 308 corresponds with parameters associated with the television receiver 104A. For example, the geographic identifier associated with the television receiver 104 may match the display criteria associated with the non-common content 308. The parameters may be stored on the storage medium 204 for utilization by the control logic 206.

In FIG. 5, the non-common content 308 includes a local price for the automobile and a telephone number for reaching local dealers for more-information. Thus, the user 110 (see FIG. 1) is presented with localized content for their locality. In some embodiments, there may be multiple instances of the non-common content 308, each being associated with a particular country, region or city. For example, there may be a first instance of the non-common content 308 that includes a telephone number for an automobile dealer in London, and there may be a second instance of the non-common content 308 that includes a telephone number for an automobile dealer in Manchester. In some scenarios, the other information, such as the pricing, may otherwise be the same. In other scenarios, the pricing and contact information may be different. For example, non-common content 308 intended for display in England may specify a price in Pounds whereas non-common content 308 intended for display in France may specify a price in Euros. In at least one embodiment, each instance of non-common content 308 is carried on a separate PID in the compound stream 300.

In at least one embodiment, the non-common content 308 may include metadata specifying an amount of time that the non-common content 308 should be displayed. For example, the metadata may specify that the non-common content 308 is to be displayed for 10 seconds, which may correspond with a portion of an advertisement. Thus, the non-common content 308 may be transmitted to the television receiver 104A once rather than continual transmission throughout the entire duration of display of the non-common content 308. In at least one embodiment, the non-common content 308 may be transmitted to the television receiver 104A in advance of its presentation. For example, the non-common content 308 may be received prior to the intended presentation of the non-common content 308. Thus, metadata associated with the non-common content 308 may specify a temporal location for presentation of the non-common content 308. In at least one embodiment, the metadata specifics the physical location for presentation of the non-common content 308, e.g., a particular region of the screen.

In at least one embodiment, the criteria may specify the portion of the video content 302 onto which the non-common content is to be displayed. In other words, the criteria may specify the coordinates of the video content 302 onto which the non-common content 308 is to be overlaid.

While the techniques described above are advantageous for presenting localized advertisements, the techniques described above may also be applied to presenting other types of localized content. For example, control logic 206 may output localized news alerts, weather alerts and emergency alerts as appropriate based on geographic identifiers. In at least one embodiment, the techniques described herein may be utilized to provide overlays which obscure offensive content, such a nudity, weapons or offensive symbols.

Further, the control logic 206 may process any type of parameter associated with the television receiver 104A to determine whether to output particular non-common content. In at least one embodiment, a user 110 may provide input specifying which types of non-common content should be outputted by the television receiver 104A. For example, the user 110 may specify that only non-common content in a particular language is to be outputted to the user 110.

In another scenario, a newscast may be associated with different types of ticker information that may be selected for viewing by a user 110 during the newscast. Thus, different users may select different types of ticker information that is presented during a newscast depending on their personal taste. For example, some users may be interested in financial information, whereas other users may desire to see sports information instead. Each type of data may be delivered in the compound stream 300 (see FIG. 3) as a separate portion of non-common content, and the control logic 206 may identify which portion of the non-common content to present based on user criteria stored on the storage medium 204.

The techniques described herein are advantageous, because the bandwidth heavy video content which is common throughout multiple regions may be transmitted in a single transmission stream. Further, the non-common content, such as localized content, is transmitted as appropriate in a small bandwidth subtitling image. Thus, a content provider may provide the appearance of localized video streams in multiple regions, without providing a separate video stream in each region.

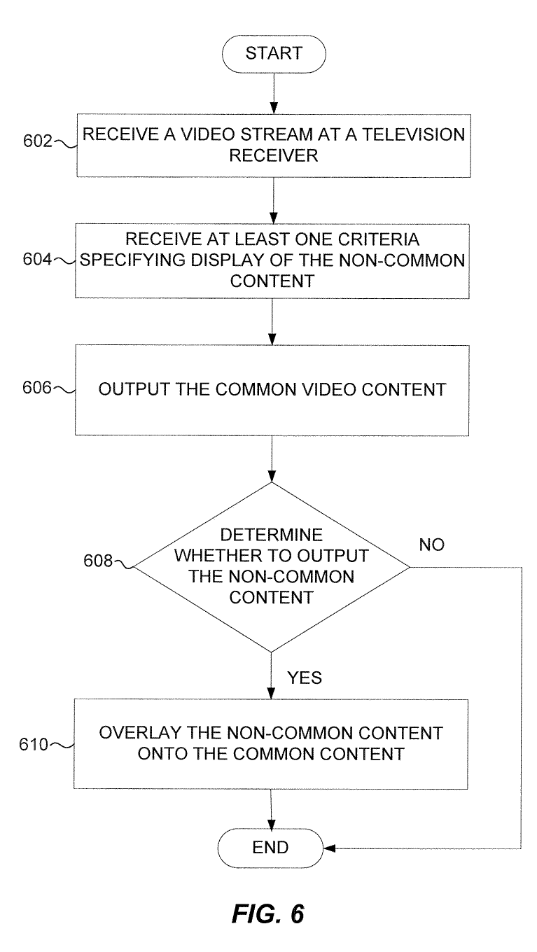

FIG. 6 illustrates a process for presentation of a video stream. The process of FIG. 6 will be described in the context of presenting a localized emergency alert to a user based on a geographic location of a television receiver. However, it is to be appreciated that the technique may be applied to presenting other types of content based on other types of criteria. The process of FIG. 6 may include other operations not illustrated for the sake of brevity.

The process includes receiving a video stream at a television receiver (operation 602). The television receiver includes common video content and a portion of non-common content. In at least one embodiment, the common video content is assigned a first PID and the non-common content is assigned a second PID. In some embodiments, there may be multiple portions of unique non-common content, which are each assigned a separate PID.

The process further includes receiving, at the television receiver, at least one criterion specifying display of the non-common content (operation 604). In at least one embodiment, the criteria may specify that television receivers in particular geographic locations should output the non-common content. For example, the compound stream may include metadata specifying that the non-common content associated with a particular PID is to be displayed in particular geographic locations. Thus, the same PID may be used at different times to present non-common content for different regions.

In at least one embodiment, a channel table specifies in advance that any content associated with a particular PID is to be displayed by a television receiver whenever it's available. Thus, multiple channels may share non-common content from the same PID. For example, a weather alert may be placed into a single PID and any television receiver in the associated geographic region may display the weather alert, regardless of the channel that the user is currently viewing.

The process further includes outputting the common video content (operation 606). For example, the common video content may be a television show which is broadcast across multiple regions, such as Hong Kong and Taiwan.

The process further includes determining whether to output the non-common content (operation 608). In at least one embodiment, the television receiver processes at least one parameter associated with the television receiver and the criteria to determine whether to output the non-common content. For example, the television receiver may process a geographic identifier associated with the television receiver to determine whether the geographic identifier corresponds with the criteria associated with the non-common content. In some embodiments, there may be multiple portions of non-common content associated with the compound stream. The television receiver may perform multiple instances of operation 608 to determine whether to output each of the portions of non-common content. For example, there may be multiple instances of non-common content, each one corresponding with different regions. In at least one embodiment, there may be multiple instances of non-common content, some of which may be displayed together to particular users.

If the television receiver determines that the non-common content should be displayed in operation 608, then the television receiver overlays the non-common content onto a portion of the common video content (operation 610). Otherwise, the television receiver continues outputting the common video content without presenting the non-common content. In at least one embodiment, the non-common content is an emergency alert targeted to a specified geographic location. For example, the emergency alert may be targeted at viewers in Hong Kong, informing the viewers that a typhoon is approaching the country. Thus, a television receiver in Hong Kong overlays the emergency alert into the video content, so that the viewer sees the emergency alert. On the other hand, a viewer in Taiwan watching the same programming does not see the emergency alert, as the viewer's television receiver determines that the non-common content (e.g., the emergency alert) should not be presented in that geographic region.

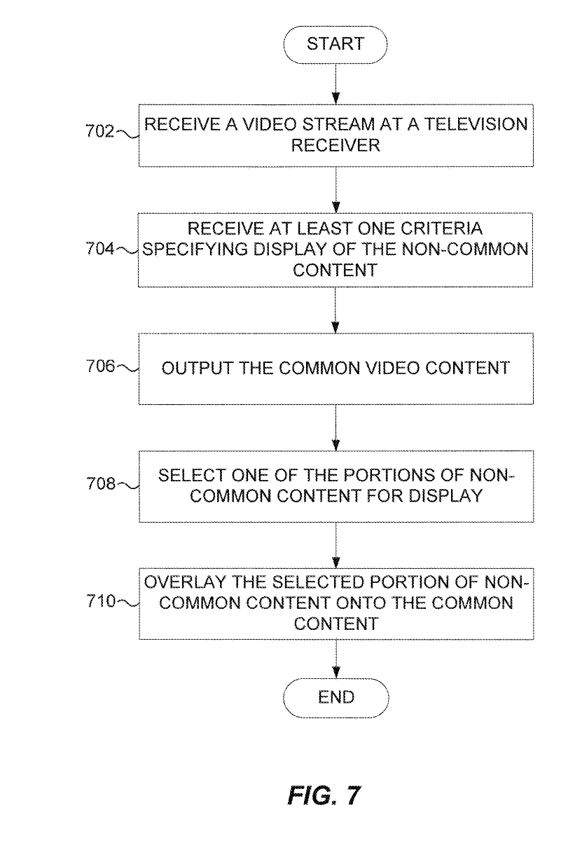

In some embodiments, there may be multiple portions of non-common content, each targeted to a particular geographic location or particular group of viewers. For example, an advertisement may be transmitted to multiple countries, and the non-common content may be dealer information for each country. FIG. 7 illustrates another embodiment of a process for presenting a video stream. The process of FIG. 7 may include other operations not illustrated for the sake of brevity.

The process includes receiving a compound stream at a television receiver (operation 702). The compound stream includes common video content and at least first and second portions of non-common content. The process further includes receiving criteria specifying in which geographic locations to display each of the portions of non-common content (operation 704). For example, the criteria may specify which PID, carrying a particular portion of non-common content, corresponds with which geographic region.

The process further includes outputting the common video content (operation 706). The process further includes selecting one of the portions of non-common content based on the criteria and parameters associated with the television receiver (operation 708). For example, the television receiver may select the applicable PID for its geographic location. The process further includes overlaying the selected non-common content onto a portion of the common video content (operation 710). Thus, through the operation of the process of FIG. 7, the television receiver may present a user with a localized advertisement.

Although specific embodiments were described herein, the scope of the invention is not limited to those specific embodiments. The scope of the invention is defined by the following claims and any equivalents therein.

I claim:

1. A method for presenting a video stream, the method comprising:
receiving a compound stream at a television receiver, the compound stream including common video content and at least one first portion of non-common content;
receiving, at the television receiver, at least one criterion specifying display of the non-common content;
outputting the common video content;
processing at least one parameter associated with the television receiver and the criterion to determine whether to output the non-common content; and
overlaying the non-common content onto a portion of the common video content responsive to a determination to output the non-common content.

2. The method of claim 1, wherein overlaying the non-common content further comprises:
overlaying an image onto the portion of the common video content.

3. The method of claim 1, wherein the common video content comprises an advertisement and wherein the non-common content comprises localized information associated with the advertisement.

4. The method of claim 1, wherein the non-common content comprises a localized news alert.

5. The method of claim 1, wherein processing the parameter further comprises:
processing a geographic identifier, associated with the television receiver, to determine whether to output the non-common content.

6. The method of claim 1, wherein the at least one criterion further specifies the portion of the common video content onto which the non-common content is to be displayed.

7. The method of claim 1, wherein the common video content transmitted to the television receiver is assigned a first packet identifier and the non-common video content is assigned a second packet identifier.

8. The method of claim 1, further comprising:
receiving a second portion of non-common content associated with the compound stream;
processing the parameter associated with the television receiver and the criterion to determine whether to output the second portion of non-common content; and
overlaying the second portion of non-common content onto the portion of the common video content responsive to a determination to output the second portion of the non-common content.

9. The method of claim 8, wherein the first portion of non-common content is associated with a first geographic location and wherein the second portion of non-common content is associated with a second geographic location, and wherein the parameter comprises a geographic identifier associated with the television receiver.

10. The method of claim 1, wherein the criterion further specifies a temporal location for presentation of the non-common content within the compound stream.

11. A television receiver comprising:
a communication interface operable to receive a compound stream, the compound stream including common video content and at least one portion of non-common content and further operable to receive at least one criterion specifying display of the non-common content;
control logic communicatively coupled to the communication interface, the control logic operable to:
output the common video content;
process at least one parameter associated with the television receiver and the criterion to determine whether to output the non-common content; and
overlay the non-common content onto a portion of the common video content responsive to a determination to output the non-common content.

12. The television receiver of claim 11, wherein the non-common content comprises an image and the control logic is operable to overlay the image onto the portion of the common video content.

13. The television receiver of claim 11, wherein the common video content comprises an advertisement and wherein the non-common content comprises localized information associated with the advertisement.

14. The television receiver of claim 11, wherein the non-common content comprises a localized news alert.

15. The television receiver of claim 11, wherein the control logic is further operable to process a geographic identifier, associated with the television receiver, to determine whether to output the non-common content.

16. The television receiver of claim 11, wherein the at least one criterion further specifies the portion of the common video content onto which the non-common content is to be displayed.

17. The television receiver of claim 11, wherein the common video content received by the communication interface is assigned a first packet identifier and the non-common video content is assigned a second packet identifier.

18. A television receiver comprising:
a communication interface operable to receive a compound stream, the compound stream including common video content, a first portion of non-common content and a second portion of non-common content further operable to receive at least one criterion specifying display of the first and the second portions of non-common content;
control logic communicatively coupled to the communication interface, the control logic operable to:
output the common video content;
process at least one parameter associated with the television receiver and the criterion to determine whether to output the first portion of non-common content or the second portion of non-common content;
overlay the first portion of non-common content onto a portion of the common video content responsive to a determination to output the first portion of non-common content; and
overlay the second portion of non-common content onto a portion of the common video content responsive to a determination to output the second portion of non-common content.

19. The television receiver of claim 18, wherein the first portion of non-common content comprises a first image and the second portion of non-common content comprises a second image.

20. The television receiver of claim 18, wherein the common video content comprises an advertisement and wherein the first portion of non-common content comprises localized information associated with the advertisement for a first geographic region and wherein the second portion of non-common content comprises localized information associated with the advertisement for a second geographic region.

21. The television receiver of claim 18, wherein the control logic is further operable to process a geographic identifier, associated with the television receiver, to determine whether to output either of the first and second portions of non-common content.
